(19) United States
(12) Patent Application Publication
(10) Pub. No.: US 2013/0199581 A1
(43) Pub. Date: Aug. 8, 2013

(54) EQUIPMENT DISINFECTING AND DRYING UNIT

(71) Applicant: Clifford Christopherson, Lakeville, MN (US)

(72) Inventor: Clifford Christopherson, Lakeville, MN (US)

(73) Assignee: ACTIVAR, INC., Minneapolis, MN (US)

(21) Appl. No.: 13/365,968

(22) Filed: Feb. 3, 2012

(51) Int. Cl. B08B 3/00

(52) U.S. Cl. 134/103.2

(57) ABSTRACT

A unit for cleaning, drying and disinfecting equipment. The unit comprises a cabinet, a baffle disposed in the cabinet spaced apart from a rear wall of the cabinet, a plurality of adjustable nozzles for directing chemically treated air at the equipment, and a means for applying atomized chemicals into the flow of air.

### BACKGROUND OF THE INVENTION

I. Field of the Invention

This invention relates generally to sanitizing and deodorizing equipment. More specifically, it relates to a device for sanitizing equipment by applying a disinfecting and deodorizing chemical to equipment by means of a directed airflow, said airflow also used to dry the equipment.

II. Discussion of the Prior Art

Many sports teams have a strong interest in protecting the health and safety of their players. Bacterial infections can keep a player from competing, or least from performing to their greatest potential. After use, sports equipment such as hockey padding, jerseys or the like, can grow bacteria and mold. This bacteria and mold can cause infections as well as unpleasant-smelling odors. Eliminating or preventing the growth of mold or bacteria on uniforms and equipment worn by player athletes will give teams the greatest chance of having consistent and productive seasons. Further, eliminating or preventing bacteria and molds in sports equipment will reduce unpleasant odors which make storage and use of sports equipment unpleasant.

Others have a need to sanitize and deodorize equipment as well. For example, hunting clothing, snowmobile clothing and other articles may need to be dried, sanitized and deodorized as well.

Previously, sports teams on the professional and amateur levels have sprayed their equipment directly with sanitizing compounds, such as ozone. Sprinkler systems have been used in locker rooms whereby ozone is sprayed throughout the entire locker room to kill bacteria and mold. Alternatively, shelving units have been created where sports equipment is placed on the shelving and sprayed with a sanitizing chemical. The problem with these prior art approaches is they do not evenly distribute the sanitizing compound (be it ozone or an atomized chemical), leaving pockets of untreated equipment or uniforms. This can leave health-threatening bacteria on the sports equipment and still leave the equipment with the unpleasant odor. Alternatively, boot driers and glove driers and the like do not isolate odor from the environment of the room. The air is allowed to circulate in the room, resulting in smelly locker rooms.

What is needed, then, is an enclosed unit where equipment can be placed for cleaning and drying. To ensure that the equipment is efficiently cleaned and dried, what is needed is an enclosed unit which uses a directed airflow for simultaneously cleaning and drying the equipment.

One object of the present invention is to provide a unit for sanitizing equipment which injects chemicals directly onto each item of equipment and dries the equipment using a moving, directed airflow.

It is still another object of this invention to provide a unit which uses moving air, heat, an ozone generator, a dehumidifier, an atomized chemical and ultraviolet light to eliminate bacteria and mold from equipment.

It is still another object of the present invention to provide an enclosed unit for sanitizing and deodorizing equipment wherein the enclosed unit can ventilate excess air through a filter to help eliminate odors after treatment.

It is a still further object of this invention to provide a unit for sanitizing and deodorizing equipment which is adaptable to a home, locker room or work setting.

### SUMMARY OF THE INVENTION

The unit for cleaning, drying and disinfecting equipment is provided. Said unit comprises a cabinet formed to define a chamber having a generally flat bottom surface, mutually perpendicular opposed side walls, a top wall and a rear wall and an open front and a latchable door assembly for closing the cabinet. At least one baffle is placed in the cabinet spaced apart from the rear wall to form a vertical passage between the baffle and the rear wall. The baffle includes a plurality of rows of regularly spaced apart ports wherein said rows are regularly spaced apart along the height dimension of the baffle. A plurality of adjustable nozzles is inserted into the ports. Each nozzle includes a first end and a second end wherein the first end is inserted into the port of the baffle and the second end extends at an angle with respect to the mid portion of the nozzle. An exterior inlet is disposed on the top wall of the unit. A blower assembly is placed in a housing section of the unit, said blower is adapted to mix air from the interior and exterior of the unit and pull air from the exterior of the unit in through the air inlet. A means for applying atomized chemicals into the flow of air from the exterior of the unit as the air mixes with the air from the interior unit is also provided. The directed airflow passes through the vertical passage and sprays through the nozzles such that atomized chemicals are applied to the equipment disposed between the baffle and the door assembly.

### BRIEF DESCRIPTION OF THE DRAWINGS

The foregoing features, aspects and advantages of the invention will become apparent to those skilled in the art from the following detailed description of an embodiment, especially when considered in conjunction with the accompanying drawings in which like numerals in the several views refer to corresponding parts:

FIG. 1 is a front perspective view of the preferred embodiment;

FIG. 2 is a front view of the preferred embodiment;

FIG. 3 is a side view of the preferred embodiment;

FIG. 4 is a sectional view of the preferred embodiment;

FIG. 5 is a perspective view of a second embodiment of the invention;

FIG. 6 is a front view of the second embodiment of the invention; and

FIG. 7 is a sectional side view of the second embodiment of the invention.

### DETAILED DESCRIPTION OF THE INVENTION

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation.

Terms such as “connected”, “connecting”, “attached”, “attaching”, “join” and “joining” are used interchangeably and refer to one structure or surface being secured to another structure or surface or integrally fabricated in one piece, unless expressively described otherwise.

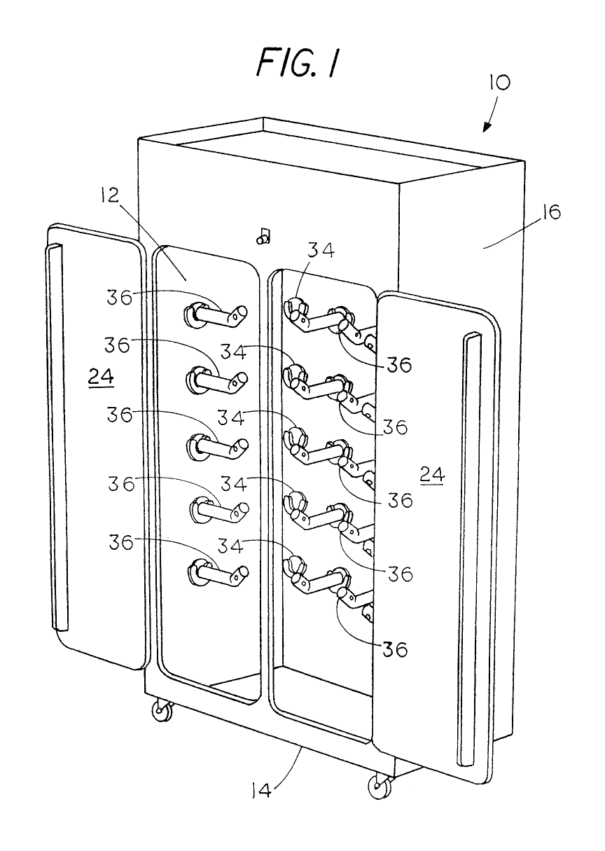

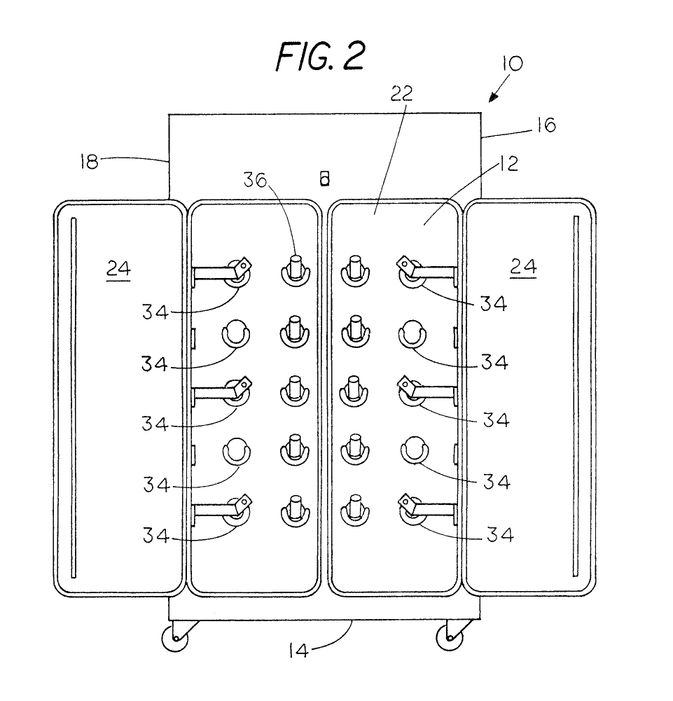

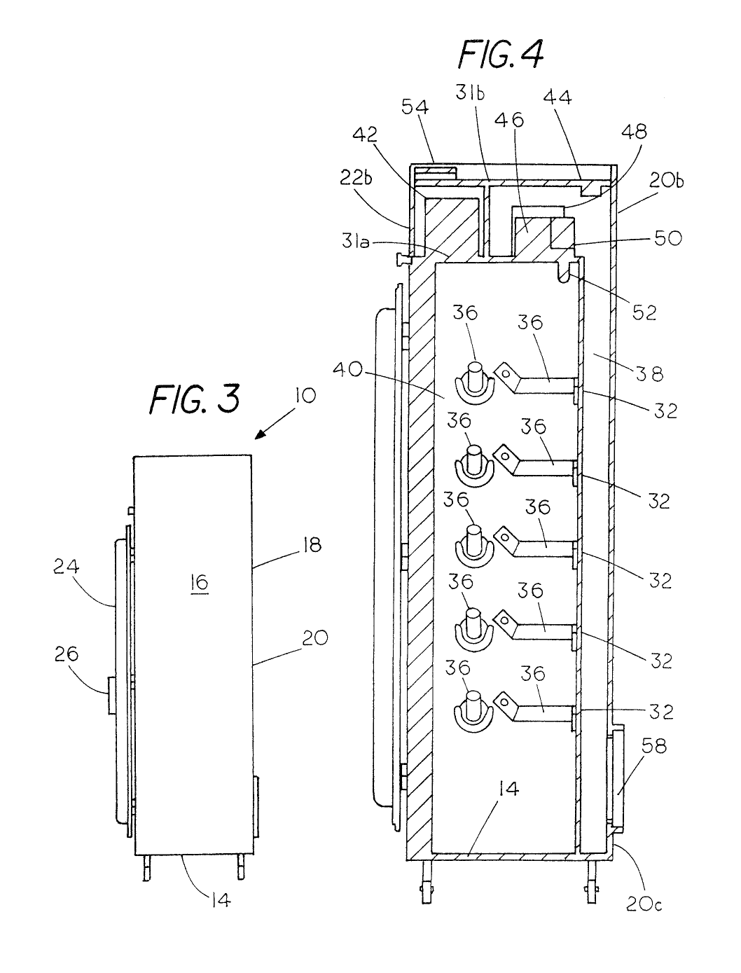

As shown in FIGS. 1, 2 and 3 there is provided a unit 10 for cleaning, drying and disinfecting equipment. The unit 10 includes a cabinet 12 defined by a floor 14, first and second opposed side walls 16 and 18, a rear panel 20 and an open front 22. As shown in FIGS. 1 and 2, a pair of front panels 24 is hingedly connected to the cabinet 10 for selectively closing the open front. A locking handle 26 on one front panel engages the other front panel 24 to close the compartment. In FIG. 2, four of the nozzles 36 are not shown in order to more clearly show the front of the plugs 34. Furthermore, the user may selectively place either a plug 34 or a nozzle 36 in a port 32.

As shown in FIG. 4, a sheet metal baffle 28 is disposed within the cabinet. The baffle 28 extends from the floor 14 to an upper housing portion 30 of the cabinet 12. The upper housing portion 30 is defined by a chamber ceiling 31a, an upper cabinet wall 31b, an upper portion 20b of the rear panel 20 and a top front panel portion 22b. The baffle 28 includes a plurality of ports 32 of uniform size. The embodiment shown in FIGS. 1 and 2 includes five rows with four ports 32 each. The ports 32 may be selectively filled either with a plug 34 or a nozzle member 36. The baffle 28 is offset from the rear panel 20 creating a plenum space 38 for directed airflow on one side of the baffle and chamber 40 on the other.

The nozzle members 36 are angularly adjustable so that they can be directed for maximum efficiency. The nozzles 36 may be selectively removed from the ports 32 and also replaced by plugs 34.

The upper housing 30 contains a blower assembly 42 and a means for applying atomized chemicals 44 and a heater 46. Optionally, the unit 10 may also include a dehumidifier unit 48, an ozone generator 50 and/or an ultraviolet light 52.

The blower 42 is connected to an exterior air inlet 54. By way of example, OEM Specialty Blowers, such as a PSC Blower, may be used for blower 42. The air inlet 54 is disposed on the upper cabinet wall 31b of the unit 10. The air inlet 54 pulls air from the exterior of the unit 10 under influence of the blower 42 and mixes the air with air from the interior of the unit 10. The blower 42 forces the mixed air past a heater 46 which heats the directed airflow. A number of commercially available electric heaters 46 may be used in the unit 10 to heat the airflow. Atomized chemicals with a dose of disinfecting, deodorized spray are injected into the directed airflow by the means for applying atomized chemicals 44 after the airflow is heated by the heater 46. The atomized chemical may be a protective coating spray with an antimicrobial agent proven to prevent the growth of odor-causing bacteria. The means for applying atomized chemicals 42 may be any atomist sprayer such as the RL Flo-Master Electric Atomist Sprayer.

After the directed airflow has been heated by the heater 46 and injected with disinfecting, deodorized spray, the directed airflow flows into the plenum chamber 38. The directed airflow egresses from the plenum chamber through the ports 32 in the baffle 28, and enters into the chamber 40 via nozzles 36 where items to be cleaned have previously been hung by the user. Nozzles 36 direct the heated, atomized airflow on to the items thus disinfecting them.

The optional ozone generator 50 may be mounted in the upper housing portion 30 proximate the heater 46. Commercially available ozone generators such as those manufactured by New Comfort are suitable. The ozone generator 50 circulates ozone into the directed airflow before it egresses into the chamber 40. It should be noted that the ozone-containing air circulates throughout the chamber 40 in order to ensure it contacts all the equipment. The optional ultraviolet light source 52 may depend from the upper housing 30 into the chamber 40. In certain other embodiments the dehumidifier 48 is also disposed in the upper housing 30. The dehumidifier 48 decreases the relative humidity in the unit 10 and thereby slows down the degeneration of O₃ to O₂.

The unit may also further include an activated charcoal filter 58 disposed on a lower portion 20c of the rear panel 20. Exhaust air in the airflow stream can be filtered using the activated charcoal filter 58 to trap undesirable odors before releasing exhaust air into the environment. An on/off switch 59 is mounted to the unit 10 for activating the blower, heater and other components of the unit. The on/off switch 59 may include a timer for keeping the unit running for a designated time.

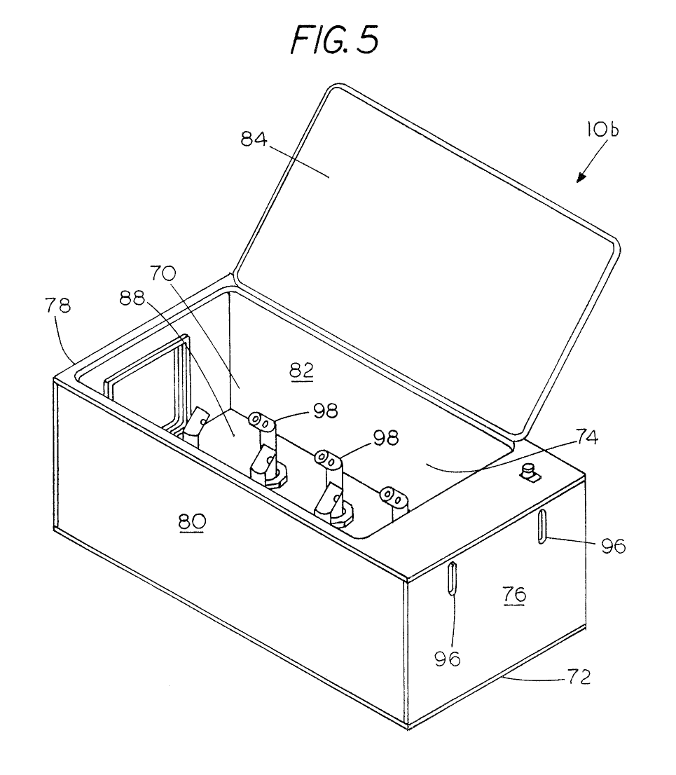

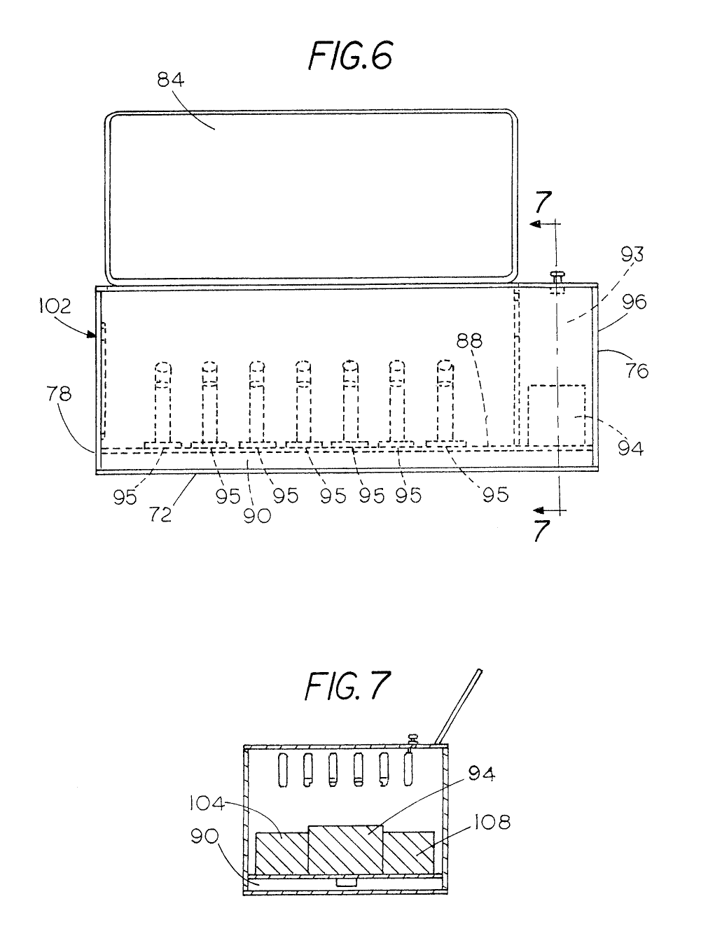

FIGS. 5 and 6 show an alternative embodiment of the unit designated as 10b. Here, the cabinet 70 is defined by a bottom panel 72, an open top 74, first and second opposed side walls 76 and 78, a front wall 80 and a rear wall 82. A latchable door 84 is hingedly connected to the unit 10b for sealing the cabinet. In the second embodiment the baffle 88 is spaced apart from the bottom panel 72, forming a horizontal plenum chamber 90 between the baffle 88 and the bottom panel 72. Like in the preferred embodiment, the baffle 88 includes a plurality of rows of ports 95. The rows 92 are regularly spaced along the length of the baffle 88.

In FIG. 6, the side housing 93 is disposed along the first side wall 76. The side housing 93 houses a blower assembly 94. Two exterior air inlets 96 are cut into the first side wall 76 for allowing exterior air to enter the unit 10b. Air from the exterior and interior of the unit mixes in the side housing 93. The blower 94 forces the mixed air past a heater which heats the mixed air. A means for applying atomized chemicals injects an atomized disinfecting, deodorizing chemical into the mixed air after the mixed air has been heated by the heater. The heated, atomized air then flows into the horizontal plenum chamber 90.

Once in the horizontal plenum chamber 90, the air egresses from the chamber through the ports 95 and a plurality of nozzles 98 mounted on the ports 95, and then is applied to equipment placed in the chamber 90. An activated charcoal filter 102 is disposed on the second side wall 78. Exhaust air in the airflow stream is filtered through the activated charcoal filter 102 to trap undesirable odors before releasing exhaust air into the environment.

As with the preferred embodiment, the alternative embodiment may include an ozone generator 104 as in FIG. 7. The ozone generator 104 is mounted in the side housing 93 and mixes ozone with the mixed air before the mixed air is directed to the horizontal plenum chamber 90. Likewise, an ultraviolet light (not shown) may be installed in the side housing 93. A dehumidifier 108 may also be disposed in the side housing 93.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

1. A unit for cleaning, drying and disinfecting equipment, said unit comprising:
(a) a cabinet formed to define a chamber having a generally flat bottom surface, opposed side walls, a top wall and a rear wall and a front having an opening with a latchable door assembly for closing the opening;
(b) at least one baffle including a plurality of rows of regularly spaced ports wherein said rows are regularly spaced apart along the height of the baffle, said baffle being spaced apart from the rear wall to form a vertical passage between the baffle and the rear wall;
(c) a plurality of adjustable nozzles, each nozzle having a first end and a second end, wherein the first end is inserted into one of the ports of the baffle, and the second end extends at an angle with respect to a mid-portion of the nozzle, said mid-portion extending between the first end and the second end of the nozzle;
(d) an exterior air inlet disposed on the top wall of the cabinet;
(e) a blower assembly adapted to draw ambient air into the passage and mixing air from the interior and exterior of the unit; and
(f) a means for applying atomized chemicals into the flow of air from the exterior of the unit as the ambient air mixes with air from the interior, it passes through the vertical passage and sprays through the nozzles such that the atomized chemicals are adapted to be applied to the equipment placed in the chamber.

2. The unit of claim 1 wherein the unit further includes an activated charcoal filter positioned to allow air to escape the cabinet through the filter.

3. The unit of claim 1 wherein the cabinet further includes a heater disposed therein to control the temperature within the unit.

4. The unit of claim 1 wherein the unit further includes an ozone generator mounted to the vertical passage for injecting ozone into the air mixture located so as to disinfect the equipment.

5. The unit of claim 1 wherein the unit further includes an ultraviolet lamp.

6. The unit of claim 1 wherein the unit further includes a dehumidifier to dehumidify the air after the equipment has been subjected to the atomized chemical spray.

7. The unit of claim 1 wherein the ports of the baffle are substantially circular in shape.

8. The unit of claim 7 wherein the unit further includes a plurality of plugs which may removably plug selected ones of the ports of the baffle.

9. The unit of claim 1 wherein there are at least five rows of laterally spaced ports.

10. The unit of claim 1 wherein the ports are substantially uniformly sized.

11. The unit of claim 1 wherein the nozzles are adapted to be selectively removed from the ports.

12. The unit of claim 1 wherein the latchable door assembly includes a first and second front panel, said first and second front panel hingedly connected, such that when closed, a locking handle mounted on the first front panel is designed to engage the second front panel to maintain the cabinet tightly sealed.

13. A unit for cleaning, drying and disinfecting equipment, said unit comprising:
(a) a cabinet formed to define a chamber having a generally flat bottom panel, opposed sidewalls, a front wall, a rear wall and a wall having an opening with a latchable door assembly for sealing the top opening;
(b) a baffle including a plurality of rows of regularly spaced ports wherein said rows are regularly spaced apart along the length of the baffle, said baffle being spaced apart from the bottom wall to form a horizontal passage between the bottom wall and the baffle;
(c) a plurality of adjustable nozzles insertable into said ports;
(d) an exterior air inlet disposed on the first side wall and communicating with the passage;
(e) a blower assembly for drawing ambient air in through the air inlet mixing air from the exterior and interior of the unit; and
(f) a means for applying atomized chemicals to the equipment whereby the atomized chemicals are injected into the flow of air from the exterior of the unit into the passage and blown through the nozzles.

14. The unit of claim 13 wherein the unit further includes an activated charcoal filter allowing air to escape the cabinet through the filter.

15. The unit of claim 14 wherein the activated charcoal filter is disposed in the second sidewall.

16. The unit of claim 13 wherein the unit further includes a heater for controlling the environment within the unit.

17. The unit of claim 13 wherein the unit further includes an ozone distribution system disposed within the unit and an ozone generator mounted in the cabinet.

18. The unit of claim 13 wherein the unit further includes an ultraviolet lamp.

19. The unit of claim 13 wherein the unit further includes a dehumidifier.

20. The unit of claim 13 wherein the ports of the baffle are substantially circular in shape.

21. The unit of claim 20 wherein the unit further includes a plurality of plugs sized to plug the ports, and said plugs are removable.

22. The unit of claim 13 wherein there are at least five rows of the laterally spaced ports.

23. The unit of claim 13 wherein the ports are substantially uniformly sized.

24. The unit of claim 13 wherein the nozzles are adapted to be selectively removed from the ports.

25. The unit of claim 13 wherein the door assembly includes a panel hingedly conducted to the unit and further includes a locking handle adapted to maintain the cabinet tightly sealed.
